(19) United States
(12) Patent Application Publication
(10) Pub. No.: US 2023/0231184 A1
(43) Pub. Date: Jul. 20, 2023

(54) SOLID ELECTROLYTE, SOLID ELECTROLYTE SOLUTION, AND METHOD OF MANUFACTURING SOLID ELECTROLYTE

(71) Applicants: TOYOTA JIDOSHA KABUSHIKI KAISHA, Toyota-shi (JP); Panasonic Holdings Corporation, Osaka (JP)

(72) Inventors: Hiroki YABE, Osaka (JP); Izuru SASAKI, Kyoto-shi (JP); Kenta NAGAMINE, Osaka (JP)

(73) Assignees: TOYOTA JIDOSHA KABUSHIKI KAISHA, Toyota-shi (JP); Panasonic Holdings Corporation, Osaka (JP)

(21) Appl. No.: 17/989,049

(22) Filed: Nov. 17, 2022

(30) Foreign Application Priority Data
Jan. 19, 2022 (JP) 2022-006606

(51) Int. Cl. H01M 10/0562; C01B 25/14

(52) U.S. Cl. CPC H01M 10/0562; C01B 25/14; H01M 2300/008; C01P 2006/40; C01P 2002/87; C01P 2002/72; C01P 2002/88

(57) ABSTRACT

A solid electrolyte includes lithium, phosphorus, sulfur, and halogen, in which, when the solid electrolyte is measured by TG-MS, a first peak derived from cyclic sulfur appears in a temperature range of 170° C. or higher and lower than 250° C., a second peak derived from the cyclic sulfur appears in a temperature range of 250° C. or higher and lower than 300° C., and a peak intensity P1 of the first peak is higher than a peak intensity P2 of the second peak.

### CROSS-REFERENCE TO RELATED APPLICATION

This application claims priority to Japanese Patent Application No. 2022-006606 filed on Jan. 19, 2022, incorporated herein by reference in its entirety.

### BACKGROUND

### 1. Technical Field

The present disclosure relates to a solid electrolyte, a solid electrolyte solution, and a method of manufacturing a solid electrolyte.

### 2. Description of Related Art

A lithium ion secondary battery including a nonaqueous electrolyte has a high voltage and a high capacity, and is widely used as a power supply for an electronic apparatus, such as a mobile phone or a laptop or for a battery electric vehicle. On the other hand, the nonaqueous electrolyte is combustible. Therefore, in the lithium ion secondary battery including a nonaqueous electrolyte, there is a concern about safety. Thus, in order to improve safety, the development of an all-solid-state battery including an incombustible solid electrolyte has progressed.

As the solid electrolyte, for example, an oxide-based solid electrolyte or a sulfide-based solid electrolyte is known. In particular, the sulfide-based solid electrolyte is expected as an electrolyte having high ion conductivity. As a document that discloses a method of manufacturing the sulfide-based solid electrolyte, there is Japanese Patent No. 6095218 (JP 6095218 B).

JP 6095218 B discloses a method of manufacturing an active material coated with a solid electrolyte by mixing an active material with a forming solution in which the solid electrolyte is dissolved in an organic solvent and drying the mixture. In addition, the same document describes that the solid electrolyte is obtained by dissolving a raw material for forming the solid electrolyte in an organic solvent and causing the raw material to react in the process of drying the obtained solution.

In addition, WO 2021/131716 discloses a method of manufacturing a new solid electrolyte not including a sulfur atom. Specifically, WO 2021/131716 discloses a solid electrolyte composition where a solid electrolyte material including halogen without including a sulfur atom is dispersed in a solvent. In addition, the same document describes that the solid electrolyte is obtained by removing the solvent from the solid electrolyte composition.

### SUMMARY

As described in JP 6095218 B, it is known that a solid electrolyte can be obtained by synthesizing a solution. However, the solid electrolyte obtained by synthesizing a solution has a problem in that the lithium ion conductivity is low.

The present disclosure provides a solid electrolyte and a solid electrolyte solution capable of improving lithium ion conductivity.

A first aspect of the present disclosure relates to a solid electrolyte including lithium, phosphorus, sulfur, and halogen. When the solid electrolyte is measured by TG-MS, a first peak derived from cyclic sulfur appears in a temperature range of 170° C. or higher and lower than 250° C., a second peak derived from the cyclic sulfur appears in a temperature range of 250° C. or higher and lower than 300° C., and a peak intensity P1 of the first peak is higher than a peak intensity P2 of the second peak.

In the first aspect of the present disclosure, the solid electrolyte may have an argyrodite structure including lithium, phosphorus, sulfur, and halogen.

In the first aspect of the present disclosure, a peak intensity ratio P1/P2 may be 1.19 or more and 2.10 or less.

In the first aspect of the present disclosure, the cyclic sulfur may be S₈.

A second aspect of the present disclosure relates to an all-solid-state battery including: a positive electrode; a negative electrode; and a solid electrolyte layer disposed between the positive electrode and the negative electrode, in which at least one of the positive electrode, the negative electrode, and the solid electrolyte layer includes the solid electrolyte.

A third aspect of the present disclosure relates to a solid electrolyte solution.

The solid electrolyte solution includes a solid electrolyte material that is dissolved in a solvent, in which: the solid electrolyte material includes lithium, phosphorus, sulfur, and halogen, and the solvent includes a first solvent in which the solid electrolyte material is soluble and a second solvent in which the solid electrolyte material is insoluble, and the second solvent has a solubility parameter of 10.5 (cal/cm)^{1/2} or less and has a vapor pressure of 0.5 kPa or less.

In the third aspect of the present disclosure, a content of the second solvent in the solvent may be 5 wt % or more and 50 wt % or less.

In the third aspect of the present disclosure, the number of carbon atoms in the second solvent may be 7 or more and 10 or less.

A fourth aspect of the present disclosure relates to a method of manufacturing a solid electrolyte including: a preparation step of preparing the solid electrolyte solution; and a removal step of removing the solvent from the solid electrolyte solution.

In the fourth aspect of the present disclosure, the removal step may include a first heating step of heating the solid electrolyte solution at a temperature of 50° C. or higher and 120° C. or lower and a second heating step of heating the solid electrolyte solution at a temperature of 140° C. or higher and 200° C. or lower after the first heating step.

According to the aspects of the present disclosure, the ion conductivity of the solid electrolyte can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart illustrating a method of preparing a solid electrolyte according to Example;

FIG. 2 is a graph in which an XRD spectrum of Comparative Example 1 and an XRD spectrum of Example 3 overlap each other;

FIG. 3 is a graph illustrating an XRD spectrum of Comparative Example 2;

FIG. 4 is a graph in which XRD spectra of Examples 1 to 3 and Comparative Example 1 overlap each other;

FIG. 5 is a graph illustrating change rates of peak intensities of main peaks, full widths at half maximum of the main peaks, and peak intensities of impurity peaks in Examples 1 to 3 and Comparative Example 1 with respect to the results in Comparative Example 1;

FIG. 6 is a graph in which XRD spectra of Examples 1 to 5 and Comparative Example 1 overlap each other;

FIG. 7 is a graph illustrating change rates of peak intensities of main peaks, full widths at half maximum of the main peaks, and peak intensities of impurity peaks in Examples 1 to 5 and Comparative Example 1 with respect to the results in Comparative Example 1;

FIG. 8 is a graph illustrating the results of DTG of Examples 1 to 5 and Comparative Examples 1 and 2;

FIG. 9 is a graph illustrating the results of TICC of Examples 1 to 5 and Comparative Examples 1 and 2;

FIG. 10 is a graph illustrating MS spectra of regions 1 to 3 of Comparative Example 1;

FIG. 11 is a graph illustrating MS spectra of regions 1 to 3 of Example 3;

FIG. 12 is a graph illustrating an MS spectrum of cyclic sulfur S₈;

FIG. 13 is a graph illustrating an MS spectrum of cyclic sulfur S₆;

FIG. 14 is a graph illustrating the results of TICC of Examples 1 to 5 and Comparative Examples 1 and 2 focusing on m/z=256; and=

FIG. 15 is a graph illustrating the results of TICC of Examples 1 to 5 and Comparative Examples 1 and 2 focusing on m/z=192.

### DETAILED DESCRIPTION OF EMBODIMENTS

### Solid Electrolyte

A solid electrolyte according to the present disclosure includes lithium, phosphorus, sulfur, and halogen, in which, when the solid electrolyte is measured by TG-MS, a first peak derived from cyclic sulfur appears in a temperature range of 170° C. or higher and lower than 250° C., a second peak derived from the cyclic sulfur appears in a temperature range of 250° C. or higher and lower than 300° C., and a peak intensity P1 of the first peak is higher than a peak intensity P2 of the second peak. The details will be described below.

### Components of Solid Electrolyte

The solid electrolyte includes lithium, phosphorus, sulfur, and halogen. The solid electrolyte may include at least one halogen (fluorine, chlorine, bromine, or iodine). That is, the solid electrolyte may include one halogen or may include two or more halogens. In addition, the solid electrolyte may include components other than lithium, phosphorus, sulfur, and halogen.

From the viewpoint of improving lithium ion conductivity, the solid electrolyte may have an argyrodite structure including lithium, phosphorus, sulfur, and halogen. Examples of the solid electrolyte having the argyrodite structure include LiₐP_{b}S_{c}X_{d} (X represents halogen, in which two or more halogens may be present). Here, 5.5≤a≤6.5, b=1, 4.5≤c≤5.5, and 0.5≤d≤1.5 may be satisfied. Examples of LiₐP_{b}S_{c}X_{d} include Li₆PS₅Cl and Li₆PS₅Br.

### Measurement by TG-MS

Thermalgravity-Mass Spectrometry (TG-MS) refers to a method in which gas produced from a sample by temperature increase and heating in TG is introduced into

MS to obtain a mass spectrum. Measurement conditions of TG-MS are as follows. The amount of a sample is 10 mg. The temperature increase rate is 10° C./min. Helium is used as a carrier gas, and the gas flow rate is 80 ml/min.

When the solid electrolyte is analyzed under the measurement conditions, a first peak derived from cyclic sulfur appears in a temperature range of 170° C. or higher and lower than 250° C., and a second peak derived from the cyclic sulfur appears in a temperature range of 250° C. or higher and lower than 300° C. A peak intensity P1 of the first peak is higher than a peak intensity P2 of the second peak. The peak intensities of the first peak and the second peak are peak intensities of total ion current chromatograms (TICC). The first peak and the second peak refer to peaks having the highest peak intensities in predetermined temperature ranges.

Here, a peak intensity ratio P1/P2 that is the peak intensity P1 of the first peak relative to the peak intensity P2 of the second peak may be more than 1.00. From the viewpoint of improving ion conductivity, the peak intensity ratio P1/P2 may be 1.10 or more, 1.19 or more, 2.10 or less, or 1.90 or less. In addition, the first peak may appear in a temperature range of 170° C. or higher and lower than 250° C. or may appear in a temperature range of 190° C. or higher and 230° C. or lower. The second peak may appear in a temperature range of 250° C. or higher and lower than 300° C. or may appear in a temperature range of 260° C. or higher and 290° C. or lower.

In the first peak and the second peak, cyclic sulfurs to be measured are the same. The reason why the same cyclic sulfur is detected in different temperature ranges is not clear but, the present inventors presume the reason to be that different reactions occur in the temperature ranges. The kind of the cyclic sulfur is not particularly limited and is, for example, S₆ or S₈. The cyclic sulfur may be Ss.

### Shape

The shape of the solid electrolyte is not particularly limited and is, for example, a particle shape. The particle size of the solid electrolyte is not particularly limited and may be, for example, 0.1 μm or more, 1 μm or more, 100 μm or less, 20 μm or less, or 10 μm or less. Here, in the present specification, “particle size” can be obtained by observing particles with a scanning electron microscope (SEM), adding up the diameters of long sides of rectangles circumscribing the particles, and dividing the obtained value by the number of the particles to obtain an average value. The number of the particles to be measured is at least 10. The number of the particles to be measured may be 100 or more.

### Effects

In the solid electrolyte according to the present disclosure having the above-described characteristics, the amount of impurity is small, and the crystallinity of the argyrodite structure is high. Accordingly, the solid electrolyte according to the present disclosure can improve ion conductivity.

In addition, the solid electrolyte according to the present disclosure may be used for, for example, a solid-state battery, such as an all-solid-state battery. Here, the solid-state battery refers to a battery including a solid electrolyte. The all-solid-state battery refers to a solid-state battery not including a liquid material.

### All-Solid-State Battery

The all-solid-state battery according to the present disclosure includes: a positive electrode; a negative electrode; a solid electrolyte layer disposed between the positive electrode and the negative electrode, in which at least one of the positive electrode, the negative electrode, and the solid electrolyte layer includes the solid electrolyte. The all-solid-state battery according to the present disclosure includes the solid electrolyte.

Therefore, the ion conductivity can be improved. Hereinafter, an aspect of each of the configurations of the all-solid-state battery according to the present disclosure will be described. Note that the all-solid-state battery according to the present disclosure is not limited to the aspect.

### Positive Electrode

The positive electrode includes a positive electrode current collector and a positive electrode active material layer. The positive electrode active material layer is disposed on the solid electrolyte layer side of the positive electrode current collector and is in contact with the solid electrolyte layer.

A material of the positive electrode current collector is not particularly limited and can be appropriately selected from well-known materials depending on the purposes. Examples of the material include Cu, Ni, Cr, Au, Pt, Ag, Al, Fe, Ti, Zn, Co, and stainless steel. The thickness of the positive electrode current collector is not particularly limited and may be appropriately set depending on desired battery performance. For example, the thickness is in a range of 0.1 μm or more and 1 mm or less.

The positive electrode active material layer includes at least a positive electrode active material. The positive electrode active material can be appropriately selected from well-known positive electrode active materials used for a lithium ion all-solid-state battery. Examples of the positive electrode active material include lithium cobalt oxide, lithium nickel cobalt aluminum oxide (NCA), lithium nickel manganese cobalt oxide (NCM), and lithium manganese oxide. The particle size of the positive electrode active material is not particularly limited and is, for example, in a range of 1 μm to 100 μm. The content of the positive electrode active material in the positive electrode active material layer is not particularly limited and is, for example, in a range of 50 wt % to 99 wt %. In addition, the surface of the positive electrode active material may be coated with an oxide layer, such as a lithium niobate layer, a lithium titanate layer, or a lithium phosphate layer.

The positive electrode active material layer may optionally include a solid electrolyte. Examples of the solid electrolyte include the solid electrolyte according to the present disclosure. In addition, the solid electrolyte can be appropriately selected from well-known solid electrolytes used for a lithium ion all-solid-state battery. Examples of the solid electrolyte include an oxide-based solid electrolyte and a sulfide-based solid electrolyte. The solid electrolyte is preferably a sulfide-based solid electrolyte. Examples of the oxide-based solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ(LiPON). Examples of the sulfide-based solid electrolyte include Li₃PS₄, Li₂S-P₂S₅, Li₂S-SiS₂, LiI-Li₂S-SiS₂, LiI-Si₂S-P₂S₅, Li₂S-P₂S₅-LiI-LiBr, LiI-Li₂S-P₂S₅, LiI-Li₂S-P₂O₅, LiI-Li₃PO₄-P₂S₅, and Li₂S-P₂S₅-GeS_{2.} The content of the solid electrolyte in the positive electrode active material layer is not particularly limited and is, for example, in a range of 1 wt % to 50 wt %.

The positive electrode active material layer may optionally include a conductive additive. The conductive additive can be appropriately selected from well-known conductive additives used for a lithium ion all-solid-state battery. Examples of the conductive additive include a carbon material, such as acetylene black, Ketjen black, or vapor-grown carbon fiber (VGCF) and a metal material, such as nickel, aluminum, or stainless steel. The content of the conductive additive in the positive electrode active material layer is not particularly limited and is, for example, in a range of 0.1 wt % to 10 wt %.

The positive electrode active material layer may optionally include a binder. The binder can be appropriately selected from well-known binders used for a lithium ion all-solid-state battery. Examples of the binder include butadiene rubber (BR), butylene rubber (IIR), acrylate-butadiene rubber (ABR), styrene-butadiene rubber (SBR), polyvinylidene fluoride (PVdF), and a polyvinylidene fluoride-hexafluoropropylene copolymer (PVDF-HFP). The content of the binder in the positive electrode active material layer is not particularly limited and is, for example, in a range of 0.1 wt % to 10 wt %.

The shape of the positive electrode active material layer is not particularly limited and is preferably a sheet shape. The thickness of the positive electrode active material layer is not particularly limited and may be appropriately set depending on desired battery performance. For example, the thickness is in a range of 0.1 μm or more and 1 mm or less.

### Negative Electrode

The negative electrode includes a negative electrode current collector and a negative electrode active material layer. The negative electrode active material layer is disposed on the solid electrolyte layer side of the negative electrode current collector and is in contact with the solid electrolyte layer.

A material of the negative electrode current collector can be appropriately selected from well-known materials depending on the purposes. Examples of the material include Cu, Ni, Cr, Au, Pt, Ag, Al, Fe, Ti, Zn, Co, and stainless steel. The thickness of the negative electrode current collector is not particularly limited and may be appropriately set depending on desired battery performance. For example, the thickness is in a range of 0.1 μm or more and 1 mm or less.

The negative electrode active material layer includes at least a negative electrode active material. The negative electrode active material can be appropriately selected from well-known negative electrode active materials used for a lithium ion all-solid-state battery. Examples of the negative electrode active material include: a silicon-based active material, such as Si, a Si alloy, or silicon oxide; a carbon-based active material, such as graphite or hard carbon; various oxide-based active materials, such as lithium titanate, and lithium metal or a lithium alloy. The particle size of the negative electrode active material is not particularly limited and is, for example, in a range of 1 μm to 100 μm. The content of the negative electrode active material in the negative electrode active material layer is not particularly limited and is, for example, in a range of 30 wt % to 90 wt %.

The negative electrode active material layer may optionally include a solid electrolyte. Examples of the solid electrolyte include the solid electrolyte according to the present disclosure. In addition, the solid electrolyte can be appropriately selected from well-known solid electrolytes used for a lithium ion all-solid-state battery. The well-known solid electrolyte is described above, and thus the description thereof will not be repeated. The content of the solid electrolyte in the negative electrode active material layer is not particularly limited and is, for example, in a range of 10 wt % to 70 wt %.

The negative electrode active material layer may optionally include a conductive additive and a binder. As the kinds of the conductive additive and the binder in the negative electrode active material layer, the same kinds of the conductive additive and the binder that can be used in the positive electrode active material layer can be used. The content of the conductive additive in the negative electrode active material layer is not particularly limited and is, for example, in a range of 0.1 wt % to 20 wt %. The content of the binder in the negative electrode active material layer is not particularly limited and is, for example, in a range of 0.1 wt % to 10 wt %.

The shape of the negative electrode active material layer is not particularly limited and is preferably a sheet shape. The thickness of the negative electrode active material layer is not particularly limited and may be appropriately set depending on desired battery performance. For example, the thickness is in a range of 0.1 μm or more and 1 mm or less.

### Solid Electrolyte Layer

The solid electrolyte layer is disposed between the positive electrode (positive electrode mixture layer) and the negative electrode (negative electrode mixture layer). The solid electrolyte layer includes at least a solid electrolyte. Examples of the solid electrolyte include the solid electrolyte according to the present disclosure. In addition, the solid electrolyte can be appropriately selected from well-known solid electrolytes used for a lithium ion all-solid-state battery. The well-known solid electrolyte is described above, and thus the description thereof will not be repeated. The content of the solid electrolyte in the solid electrolyte layer is not particularly limited and is, for example, in a range of 50 wt % to 99 wt %.

In addition, the solid electrolyte layer may optionally include a binder. As the kind of the binder in the solid electrolyte layer, the same kind of the binder that can be used in the positive electrode active material layer can be used. The content of the binder in the solid electrolyte layer is not particularly limited and is, for example, in a range of 0.1 wt % to 10 wt %.

The shape of the solid electrolyte layer is not particularly limited and is preferably a sheet shape. The thickness of the solid electrolyte layer is not particularly limited and may be appropriately set depending on desired battery performance. For example, the thickness is in a range of 0.1 μm or more and 1 mm or less.

### Method of Manufacturing All-Solid-State Battery

The all-solid-state battery can be prepared using a well-known method. For example, the material forming the positive electrode active material layer is mixed with a predetermined solvent to obtain a slurry, and the obtained slurry is applied to a substrate or a current collector and dried to obtain the positive electrode active material layer. Using the same method, the negative electrode active material layer and the solid electrolyte layer can be prepared. Next, the electrode layer (and the current collector) is laminated in a predetermined order and is pressed at a predetermined pressure. As a result, a laminate can be obtained. The solid electrolyte layer may be obtained by applying a solid electrolyte solution described below to a substrate and drying the applied solid electrolyte solution.

### Solid Electrolyte Solution

In the solid electrolyte solution according to the present disclosure, a solid electrolyte material is dissolved in a solvent, the solid electrolyte material includes lithium, phosphorus, sulfur, and halogen, and the solvent includes a first solvent in which the solid electrolyte is soluble and a second solvent in which the solid electrolyte is insoluble. The second solvent has a solubility parameter of 10.5 (cal/cm)^{1/2} or less and has a vapor pressure of 0.5 kPa or less. The solid electrolyte according to the present disclosure can be obtained by removing the solvent from the solid electrolyte solution according to the present disclosure.

### Solid Electrolyte Material

The solid electrolyte material includes lithium, phosphorus, sulfur, and halogen. From the viewpoint of improving the crystallinity of the argyrodite structure, the solid electrolyte material may be formed of lithium, phosphorus, sulfur, and halogen. The proportions of lithium, phosphorus, sulfur, and halogen in the solid electrolyte material are appropriately set depending on the components of the solid electrolyte. Specific examples of the material in the solid electrolyte material include Li₂S, P₂S₅, LiX (X represents halogen), and Li₃PS₄. By appropriately combining the materials, the solid electrolyte material can be prepared.

The content of the solid electrolyte material is not particularly limited and can be appropriately set. For example, the content of the solid electrolyte material with respect to 100 wt % of the solid electrolyte solution may be 0.1 wt % or more, 1 wt % or more, 50 wt % or less, or 10 wt % or less. When the content of the solid electrolyte material is less than 0.1 wt %, a long period of times is taken for drying. When the content of the solid electrolyte material is more than 50 wt %, the crystallinity of the obtained solid electrolyte is likely to be deteriorate, and the solid electrolyte is likely to include impurity. Accordingly, the ion conductivity of the solid electrolyte is likely to deteriorate.

### Solvent

As the solvent, a solvent in which the solid electrolyte material is soluble can be used. The solid electrolyte solution is a solution in which the solid electrolyte material is uniformly dissolved. The solvent includes a first solvent in which the solid electrolyte is soluble and a second solvent in which the solid electrolyte is insoluble. When the solvent is removed from the solid electrolyte solution, the solvent may be formed of the first solvent and the second solvent from the viewpoint of obtaining a solid electrolyte having high ion conductivity.

In the solvent, the total content of the first solvent and the second solvent may be 80 wt % or more and 90 wt % or more. The solvent may be formed of the first solvent and the second solvent. In the solvent, a proportion of the first solvent and the second solvent may be in a range of first solvent:second solvent=5:95 to 50:50.

### First Solvent

The first solvent is a solvent in which the solid electrolyte material is soluble. “The solvent in which the solid electrolyte material is soluble” refers to a solvent in which all of the materials forming the solid electrolyte material are soluble. For example, when the solid electrolyte material is put into the first solvent and the solution is stirred under conditions of room temperature (25° C.), 6 hours to 12 hours, and 500 rpm, as long as the solid electrolyte material can be dissolved in the first solvent at 10 mg/2 ml or higher, the first solvent can be considered as a solvent in which the solid electrolyte material is soluble.

The first solvent may be a solvent in which the solubility of the solid electrolyte material is 100 mg/2 ml.

The first solvent may be formed of a single solvent or a plurality of solvents. When the first solvent is formed of a plurality of solvents, all of the solvents forming the first solvent do not need to be the solvents in which the solid electrolyte material is soluble.

The first solvent obtained by mixing a plurality of solvents may be a solvent in which the solid electrolyte material is soluble.

As the first solvent, a solvent having a lower boiling point than the second solvent may be selected. When the first solvent is formed of a plurality of solvents, all of the solvents forming the first solvent have a lower boiling point than the second solvent.

As a result, when the solvents are removed from the solid electrolyte solution, the first solvent is removed first. Therefore, the solid electrolyte can be deposited under mild conditions. From the viewpoint of further improving the effect, as the first solvent, a solvent having a boiling point of 120° C. or lower may be selected, a solvent having a boiling point of 100° C. or lower may be selected, or a solvent having a boiling point of 50° C. or higher may be selected.

Examples of the first solvent include alcohol, ether, ester, amine, and amide. The first solvent may include solvents of C1 to C5 or may include solvents of C1 to C4. Examples of the alcohol include methanol, ethanol, propanol, and butanol. Examples of the ether include tetrahydrofuran and diethyl ether. Examples of the ester include methyl propionate and ethyl propionate. Examples of the amine include ethylenediamine. Examples of the amide include N-methylformamide and N,N-dimethylformamide. The solvents may be used alone or may be mixed to be used. Among these, the first solvent may be a mixed solvent of the alcohol and the ether, or may be a mixed solvent of tetrahydrofuran (THF) and ethanol (EtOH).

The content of the first solvent with respect to 100 wt % of all of the solvents may be 50 wt % or more, 60 wt % or more, 95 wt % or less, 90 wt % or less, or 80 wt % or less.

### Second Solvent

The second solvent is a solvent in which the solid electrolyte material is insoluble. This represents that the solubility parameter of the second solvent is 10.5 (cal/cm)^{1/2} or less. In addition, the vapor pressure of the second solvent is 0.5 kPa or less. This way, the second solvent is a solvent in which the solubility of the solid electrolyte material is very low and is difficult to exhibit.

The solubility parameter is calculated from a square root (cal/cm³)^{1/2} of heat of evaporation needed to evaporate 1 cm³ of liquid. Examples of the reference document include PAC, 2008, 80, 233 (Glossary of terms related to solubility (IUPAC Recommendations 2008)) on page 264. The solubility parameter described in the present specification refers to a solubility parameter at 25° C.

The vapor pressure refers to a pressure of the vapor of a material that is in phase equilibrium with a liquid or a solid of the material. The vapor pressure is a physical property value unique to the material. The vapor pressure described in the present specification refers to a vapor pressure at 25° C.

By adjusting the solubility parameter of the second solvent to be 10.5 (cal/cm)^{1/2} or less, the solubility of the solid electrolyte material in all of the solvents decreases, and thus the crystalline solid electrolyte is likely to be deposited. In addition, by adjusting the vapor pressure of the second solvent to be 0.5 kPa or less, when the solvent is removed, the solid electrolyte can be deposited under mild conditions. Therefore, the crystalline solid electrolyte is likely to be deposited. Accordingly, the solid electrolyte solution includes the second solvent such that the solid electrolyte having high crystallinity is likely to be deposited, and the solid electrolyte is inhibited from including impurity. Accordingly, in the solid electrolyte obtained from the solid electrolyte solution, the ion conductivity is improved.

The second solvent may be formed of a single solvent or a plurality of solvents. When the second solvent is formed of a plurality of solvents, all of the solvents forming the second solvent do not need to satisfy the solubility parameter and the vapor pressure.

The solubility parameter of the second solvent may be 9.4 (cal/cm)^{1/2} or less. The lower limit value of the solubility parameter of the second solvent is not particularly limited. For example, the solubility parameter of the second solvent may be 1.0 (cal/cm)^{1/2} or more, 5.0 (cal/cm)^{1/2} or more, or 8.8 (cal/cm)^{1/2} or more.

The vapor pressure of the second solvent may be 0.35 kPa or less, 0.25 kPa or less, or 0.1 kPa or less. The lower limit value of the vapor pressure of the second solvent is not particularly limited. For example, the vapor pressure of the second solvent may be 0.01 kPa or more and 0.05 kPa or more.

As the second solvent, a solvent having a higher boiling point than the first solvent may be selected. When the second solvent is formed of a plurality of solvents, all of the solvents forming the second solvent have a higher boiling point than the first solvent. As a result, when the solvents are removed from the solid electrolyte solution, the first solvent is removed first. Therefore, the solid electrolyte can be deposited under mild conditions. From the viewpoint of further improving the effect, as the second solvent, a solvent having a boiling point of 150° C. or higher may be selected, a solvent having a boiling point of 180° C. or higher may be selected, a solvent having a boiling point of 200° C. or higher may be selected, a solvent having a boiling point of 300° C. or lower may be selected, or a solvent having a boiling point of 250° C. or lower may be selected.

The second solvent is not particularly limited as long as it is a solvent that satisfies the ranges of the solubility parameter and the vapor pressure. For example, a solvent having 7 or more and 10 or less of carbon atoms may be selected. Specific examples of the second solvent include para-chlorotoluene, mesitylene, and tetralin.

The content of the second solvent with respect to 100 wt % of all of the solvents may be 5 wt % or more, 10 wt % or more, 20 wt % or more, 50 wt % or less, or 40 wt % or less. As a result, the solid electrolyte can be deposited under mild conditions. Therefore, the solid electrolyte having higher crystallinity can be obtained, and the ion conductivity of the solid electrolyte can be improved.

The solid electrolyte and the solid electrolyte material are easily reactive with water, and thus a dehydrated solvent needs to be used.

### Other Materials

The solid electrolyte solution may optionally include a binder. As the binder, a binder that can be used for the solid electrolyte layer can be used. The content of the binder can be appropriately set such that the desired solid electrolyte can be obtained.

### Method of Manufacturing Solid Electrolyte

The method of manufacturing the solid electrolyte according to the present disclosure includes: a preparation step of preparing the solid electrolyte solution; and a removal step of removing the solvent from the solid electrolyte solution.

### Preparation Step

The preparation step is a step of preparing the solid electrolyte solution. A method of preparing the solid electrolyte solution is not particularly limited. The solid electrolyte solution may be obtained simply by mixing the solid electrolyte material and the solvents or may be obtained by dissolving the solid electrolyte material in the first solvent and subsequently adding the second solvent thereto. In addition, a predetermined reaction may be caused to progress in the process of preparing the solid electrolyte solution.

For example, the preparation step may include: a first step of suspending Li₂S and P₂S₅ in the first solvent (for example, an ether solvent) to prepare a Li₃PS₄ suspension; a second step of adding the Li₃PS₄ suspension to the first solvent (for example, an alcohol solution) in which Li₂S and LiX are dissolved to prepare a solution in which the solid electrolyte material is dissolved in the first solvent; and a third step of adding the obtained solution to the second solvent. This way, the solid electrolyte solution may be prepared.

### Removal Step

The removal step is a step of removing the solvent from the solid electrolyte solution. A method of removing the solvent from the solid electrolyte solution is not particularly limited. The solvent may be removed by heating the solid electrolyte solution or by heating the solid electrolyte solution in a reduced pressure state. The heating temperature may be 50° C. or higher, 100° C. or higher, 150° C. or higher, 300° C. or lower, 250° C. or lower, or 200° C. or lower. The heating atmosphere may be an inert atmosphere, a reduced-pressure atmosphere, or a vacuum. The reduced-pressure atmosphere may be lower than the atmospheric pressure and is, for example, 0.01 Pa to 10 Pa. The heating time may be 30 minutes or longer, 1 hour or longer, 12 hours or shorter, or 6 hours or shorter.

In addition, the heating step may be divided into two stages. That is, the removal step may include two heating steps. Specifically, the removal step may include: a first heating step of heating the solid electrolyte solution at a low temperature; and a second heating step of heating the solid electrolyte solution at a high temperature after the first heating step. By heating the solid electrolyte solution at a low temperature, a low boiling point solvent (for example, the first solvent; or the first solvent and the second solvent may also be azeotropically removed) can be removed from the solid electrolyte solution. Next, by heating the solid electrolyte solution at a high temperature, a high boiling point solvent (for example, the second solvent; or the first solvent and the second solvent may also be azeotropically removed) can be removed from the solid electrolyte solution. This way, by dividing the heating step into two stages, bumping can be inhibited, and the solid electrolyte can be deposited under milder conditions. Therefore, the high crystalline solid electrolyte can be obtained. Accordingly, the ion conductivity of the solid electrolyte can be further improved.

The heating temperature in the first heating step may be a temperature at which the first solvent can be removed. For example, the heating temperature may be 50° C. or higher, 70° C. or higher, 120° C. or lower, or 100° C. or lower. The heating atmosphere in the first heating step may be an inert atmosphere, a reduced-pressure atmosphere (for example, 0.01 Pa to 10 Pa), or a vacuum. The heating time in the first heating step may be 10 minutes or longer, 30 minutes or longer, 2 hours or shorter, or 1 hour or shorter.

The heating temperature in the second heating step may be a temperature at which the second solvent can be removed. For example, the heating temperature may be 130° C. or higher, 140° C. or higher, 150° C. or higher, 300° C. or lower, 250° C. or lower, 200° C. or lower, or 180° C. or lower. The heating atmosphere in the second heating step may be an inert atmosphere, a reduced-pressure atmosphere (for example, 0.01 Pa to 10 Pa), or a vacuum. The heating time in the second heating step may be 30 minutes or longer, 1 hour or longer, 12 hours or shorter, or 6 hours or shorter.

The removal step may be performed on a hot plate or may be performed on a substrate such as a metal foil.

Hereinafter, the present disclosure will be further described using Examples.

### Preparation of Solid Electrolyte

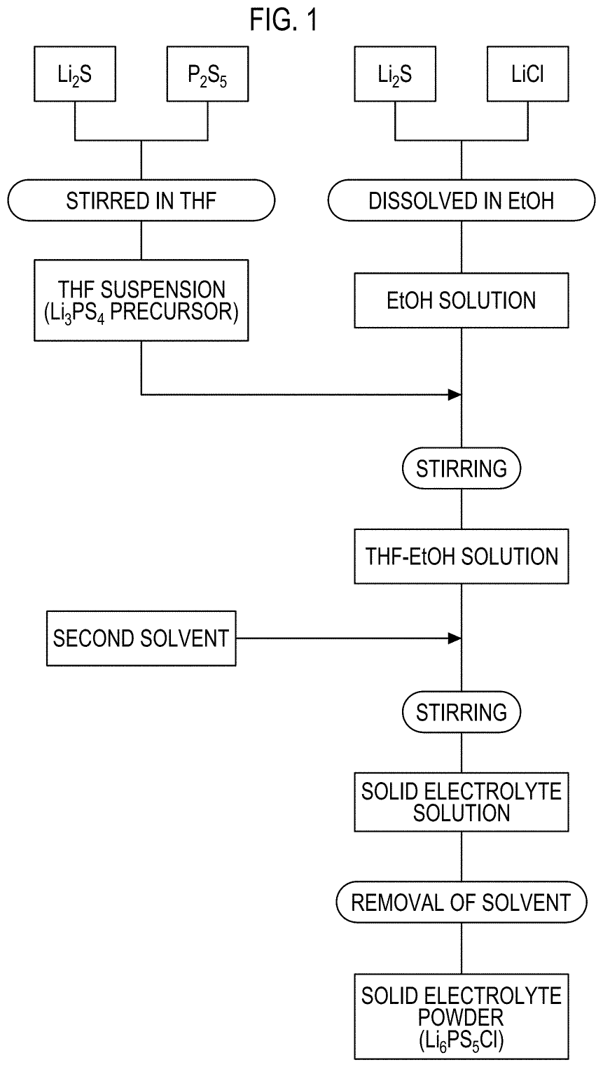

Solid electrolytes according to Examples 1 to 5 and Comparative Examples 1 and 2 were prepared based on the following procedures. FIG. 1 is a flowchart illustrating a method of preparing the solid electrolyte.

First, Li₂S, P₂S₅, and dehydrated THF were mixed in an argon glove box in an Ar atmosphere at a dew point of −60° C. or lower. A molar ratio between Li₂S and P₂S₅ was 3:1. By stirring the obtained mixture overnight, a THF suspension including Li₃PS₄ was obtained.

Next, Li₂S and LiCl were dissolved in super-dehydrated ethanol (EtOH) to obtain an EtOH solution. A molar ratio between Li₂S and LiCl was 1:1. Next, by mixing the THF suspension and the EtOH solution, a THF-EtOH solution (the solution in which the solid electrolyte material was dissolved in the first solvent) was obtained.

In the THF-EtOH solution, a molar ratio between Li₂S, P₂S₅, and LiCl used as the solid electrolyte material was 5:1:2. In addition, the total concentration of the solid electrolyte material in the solution was 4.5 mass %.

Next, the second solvent shown in Table 1 was added to the THF-EtOH solution and was stirred to obtain a solid electrolyte solution. The solid electrolyte solution was heated on a hot plate in an inert atmosphere under conditions of 80° C. and 30 minutes. Next, the solid electrolyte solution was further heated in a vacuum under conditions of 170° C. and 2 hours. As a result, solid electrolyte powders (Li₆PS₅Cl) according to Examples 1 to 5 and Comparative Examples 1 and 2 were obtained.

### XRD Measurement

The XRD measurement was performed such that the obtained solid electrolyte did not come into contact with the atmosphere with attention. The XRD measurement was performed using a continuous method under conditions of 10° to 80°, 20/CuKα, 10°/min, and a scan step of 0.01°.

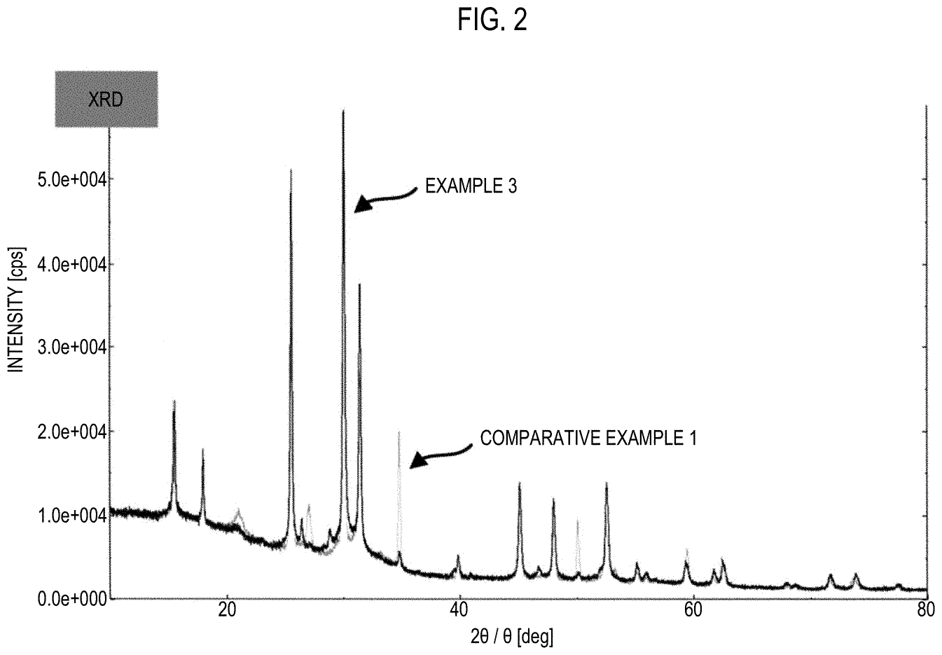

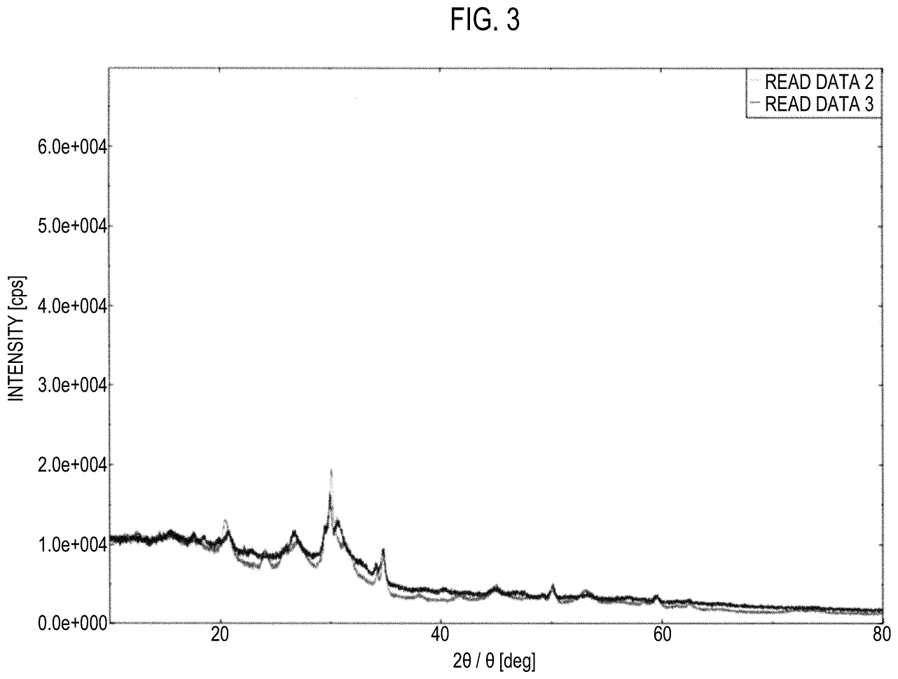

FIG. 2 is a diagram where an XRD spectrum according to Comparative Example 1 to which the second solvent was not added and an XRD spectrum according to Example 3 to which 10 wt % of tetralin was added overlap each other. In addition, FIG. 3 shows an XRD spectrum according to Comparative Example 2 to which 10 wt % of NMP was added.

In the XRD spectrum, a main peak showing Li₆PS₅Cl of an argyrodite structure appeared at about 30°. In FIG. 2, when the main peaks were compared, it was able to be observed that the peak of Example 3 to which the second solvent was added was higher than the peak of Comparative Example 1 to which the second solvent was not added, and the crystallinity was improved. In addition, in Comparative Example 1, a large impurity peak appeared at about 26.5° and the impurity peak in Example 3 was lower than that of Comparative Example 1. Accordingly, it was found that, by adding the second solvent, impurity was reduced.

On the other hand, in Comparative Example 2 in which N-methylpyrrolidone (NMP) was used as the second solvent, it was found that, as illustrated in FIG. 3, the peak of the argyrodite structure could not be verified, and the crystal structure was broken. The reason for this is presumed to be that, since the solubility parameter of the NMP is high and the polarity is high, some reaction with the solid electrolyte progressed.

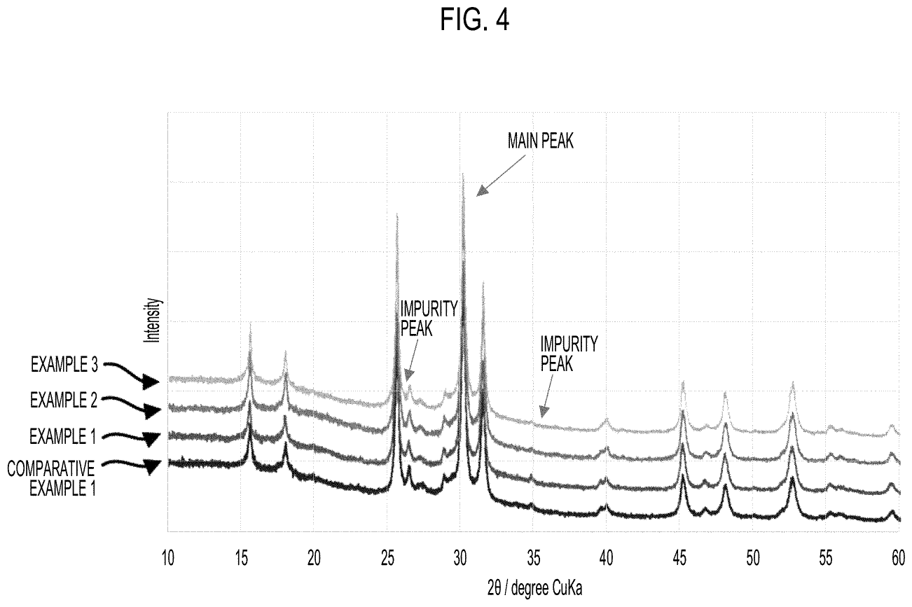

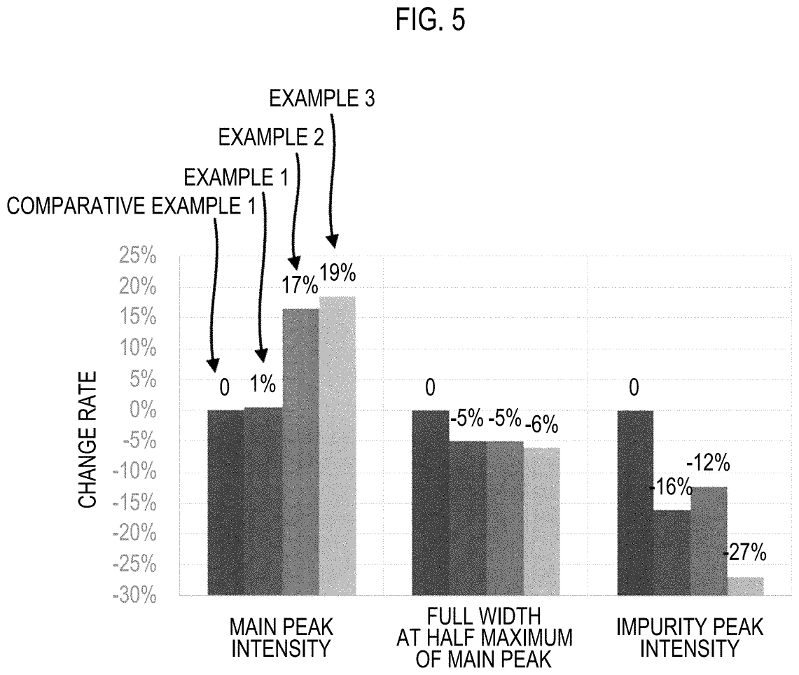

Next, a change in the main peak (about 30°) and the impurity peak (about) 26.5° depending on the kind of the second solvent was investigated. FIG. 4 illustrates a diagram where the XRD spectra of Examples 1 to 3 and Comparative Example 1 overlapped each other. In addition, FIG. 5 illustrates change rates of peak intensities of the main peaks, full widths at half maximum of the main peaks, and peak intensities of the impurity peaks in Examples 1 to 3 and Comparative Example 1 with respect to the results in Comparative Example 1, respectively.

As can be seen from FIGS. 4 and 5, as the vapor pressure of the second solvent decreased (the boiling point increased), the main peak increased. In addition, the impurity peak also tended to decrease. In addition, the full widths at half maximum of the main peaks in Examples 1 to 3 to which the second solvent was added exhibited substantially the same behavior and were decreased by 5% to 6% with respect to Comparative Example 1. It is presumed from the above results that, by adding the second solvent, as the crystallinity increases and the vapor pressure decreases (the boiling point increases), the crystallinity further increases and the amount of impurity decreases.

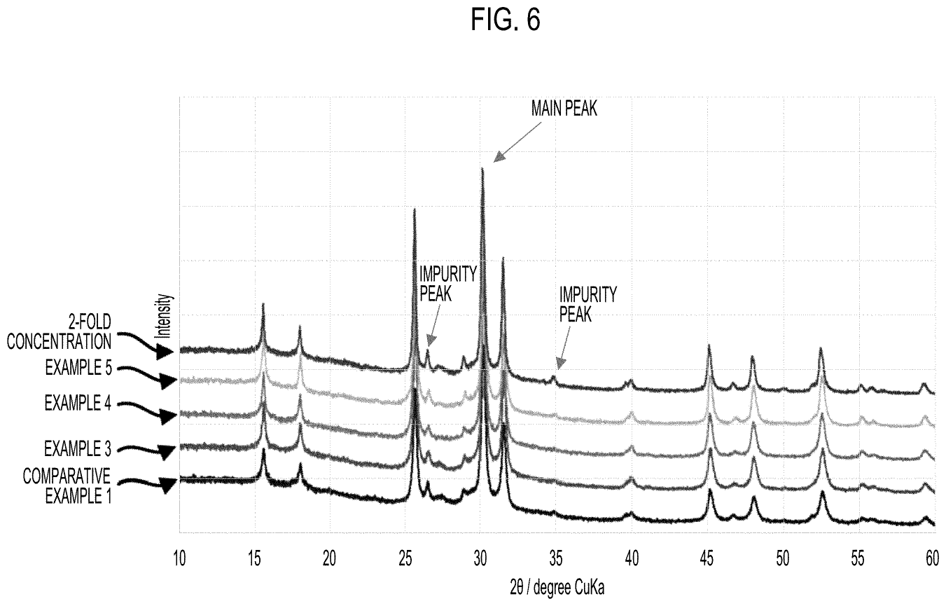

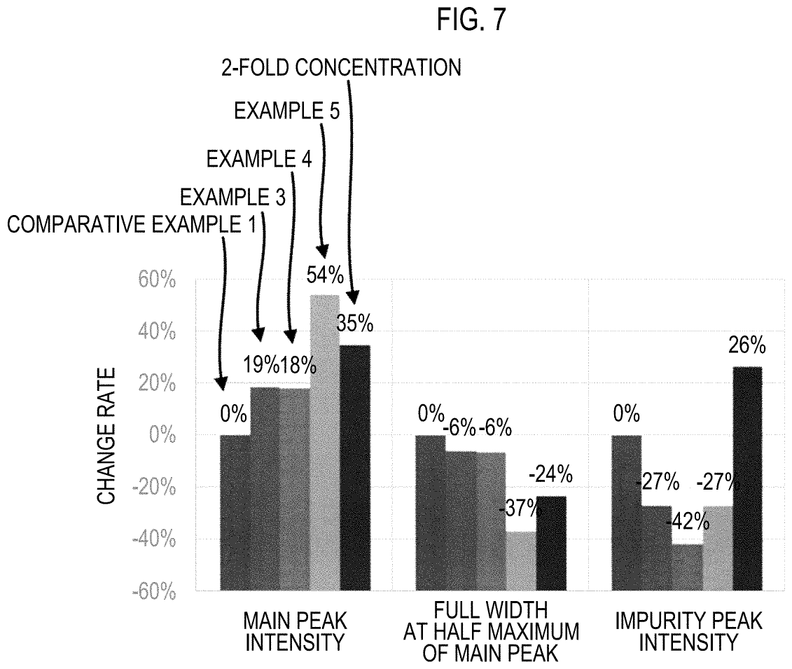

Next, a change in the main peak (about 30°) and the impurity peak (about) 26.5° depending on the content of the second solvent was investigated. FIG. 6 illustrates a diagram where the XRD spectra of Examples 3 to 5 and Comparative Example 1 overlapped each other. In addition, FIG. 7 illustrates change rates of peak intensities of the main peaks, full widths at half maximum of the main peaks, and peak intensities of the impurity peaks in Examples 3 to 5 and Comparative Example 1 with respect to the results in Comparative Example 1, respectively. In addition, FIGS. 6 and 7 also illustrate the results of an XRD spectrum of a solid electrolyte prepared by 2-fold concentration. The test example of the 2-fold concentration was a reference example, in which the solid electrolyte was prepared from the solid electrolyte solution concentrated to 2 times by removing a part of the solvent using a rotary evaporator.

As can be seen from FIGS. 6 and 7, as the addition amount of the second solvent increased (the polarity of the solid electrolyte solution decreased), the main peak increased, and the full width at half maximum of the main peak decreased. Accordingly, it is presumed that, as the addition amount of the second solvent increases (the polarity of the solid electrolyte solution decreases), the crystallinity increases. On the other hand, regarding the impurity peak, in Example 4 to which 30 wt % of the second solvent was added, the impurity peak was reduced the most. In addition, in Examples 3 to 5 to which the second solvent was added, the impurity peak tended to decrease.

It is presumed from the above results that, in order to improve the crystallinity of the solid electrolyte and to reduce the amount of impurity, the following characteristics should be noted. (1) It should be noted the second solvent is a low-polarity solvent where the solubility parameter is low. For example, the solubility parameter of the second solvent may be 10.5 (cal/cm)^{1/2} or less. As in Comparative Example 2, when the solubility parameter is high, the crystal structure is broken. (2) It should be noted that the second solvent is a solvent where the vapor pressure is low (the boiling point is low). In addition, as the vapor pressure (boiling point) of the second solvent decreases, the crystallinity can increase, and the solid electrolyte having a small amount of impurity can be obtained. For example, the vapor pressure of the second solvent may be 0.5 kPa or less, and the boiling point of the second solvent may be 150° C. or higher.

The above results are collectively shown in Table 1. Here, the peak intensity ratios of the main peaks (about 30°) and the impurity peaks (about 26.5°) in Table 1 were calculated with respect to Comparative Example 1.

### TG-MS Measurement

Regarding the obtained solid electrolyte powder, TG-MS measurement was performed. Measurement conditions are as follows. The amount of a sample was 10 mg.

The temperature increase rate was 10° C./min. Helium was used as a carrier gas, and the gas flow rate was 80 ml/min.

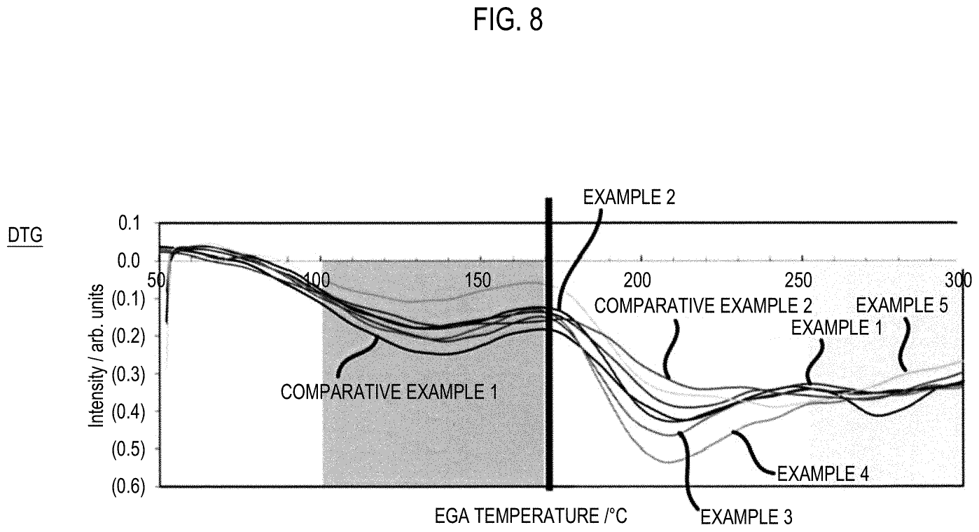

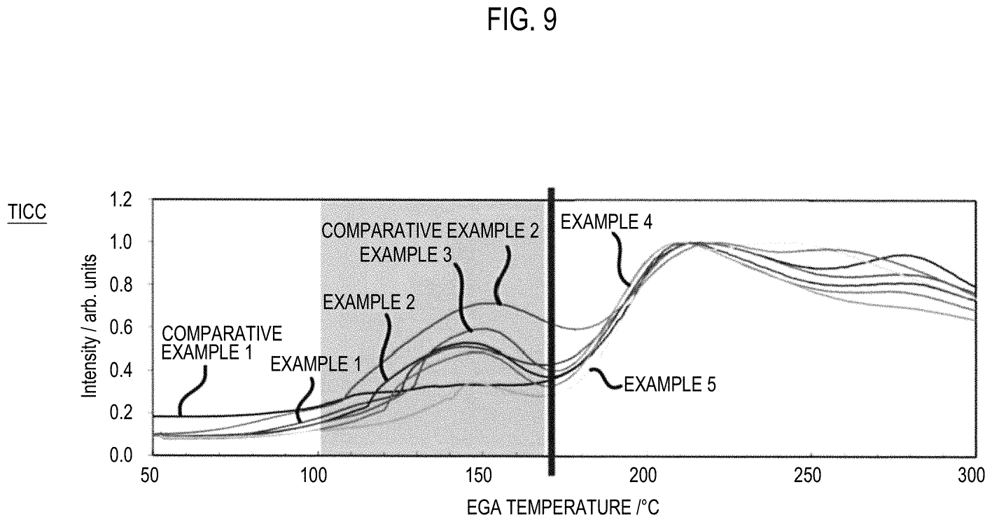

FIG. 8 illustrates the results of differential thermogravimetry (DTG). FIG. 9 illustrates the measurement results of total ion current chromatogram (TICC).

It was found from FIGS. 8 and 9 that the solid electrolyte had three temperature ranges where a decrease in mass and the production of gas occurred as the temperature increased. Specifically, the three ranges include (1) a range 1 of room temperature or higher and lower than 170° C., (2) a range 2 of 170° C. or higher and lower than 250° C., and (3) a range 3 of 250° C. or higher and lower than 300° C.

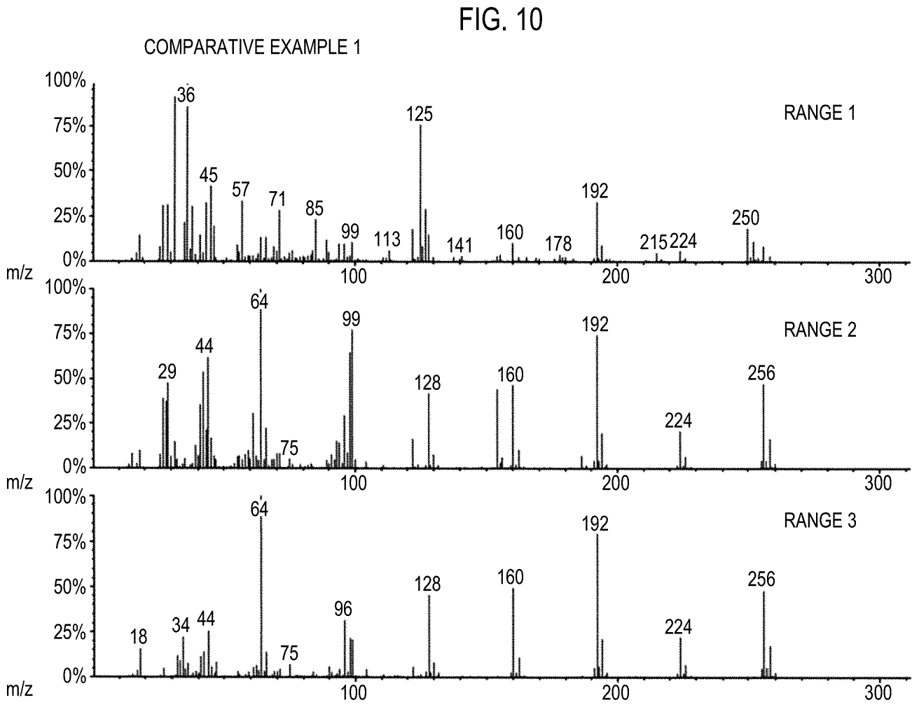

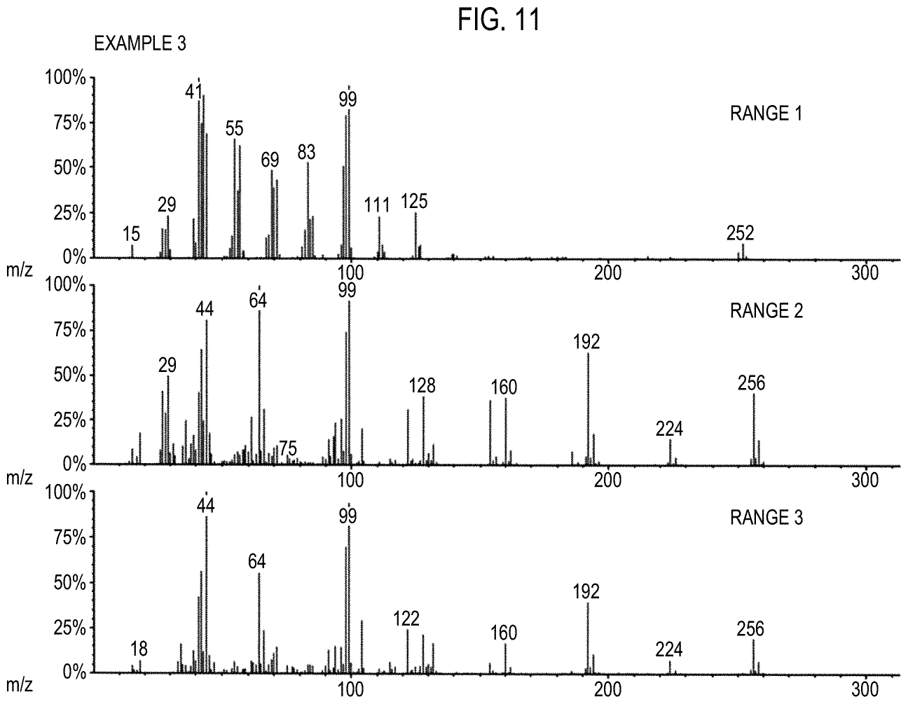

Next, gas produced in each of the ranges was analyzed by MS. FIG. 10 illustrates an MS spectrum of each of the ranges of Comparative Example 1. FIG. 11 illustrates an MS spectrum of each of the ranges of Example 3.

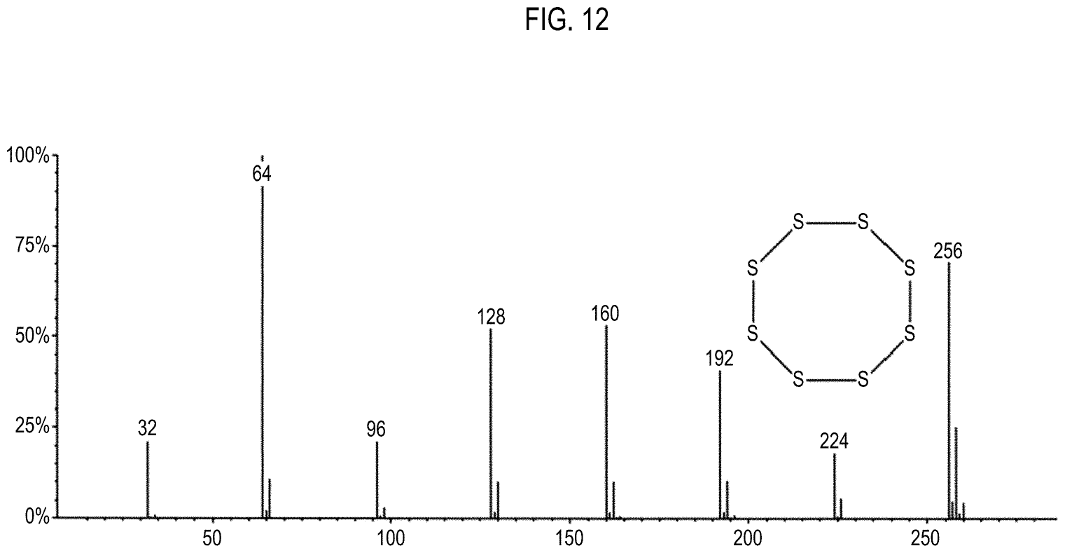

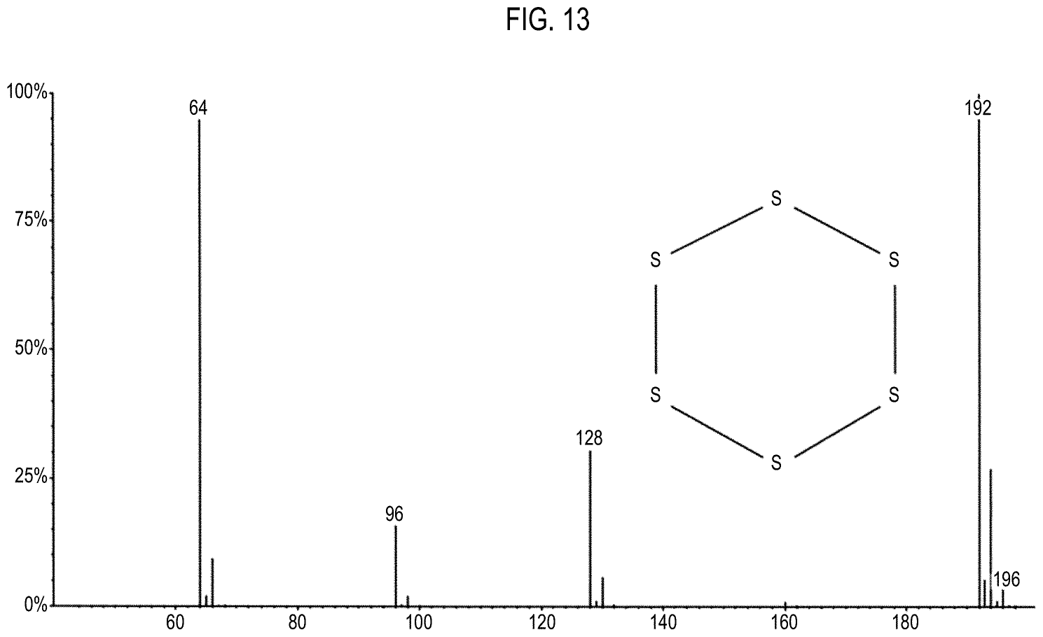

It was able to be verified from a comparison between FIGS. 10 and 11 that different gases were produced from the regions although common gas was present. Among these, common peaks of m/z=192 and m/z=256 were focused on. In consideration of the components of the solid electrolyte, it was able to be presumed that the peaks were derived from cyclic sulfurs (S6 and S₈). Accordingly, the peaks were identified. FIG. 12 illustrates an MS spectrum of the cyclic sulfur S₈. FIG. 13 illustrates an MS spectrum of the cyclic sulfur S₆.

It was presumed from a comparison between FIGS. 10 to 13 that peaks of m/z=192 and m/z=256 appearing in the MS spectra of FIGS. 10 and 11 were derived from the cyclic sulfurs S₆ and S₈. In addition, it was presumed that the major component of gas produced from the solid electrolyte was the cyclic sulfur S₈ based on the size of the peak intensity.

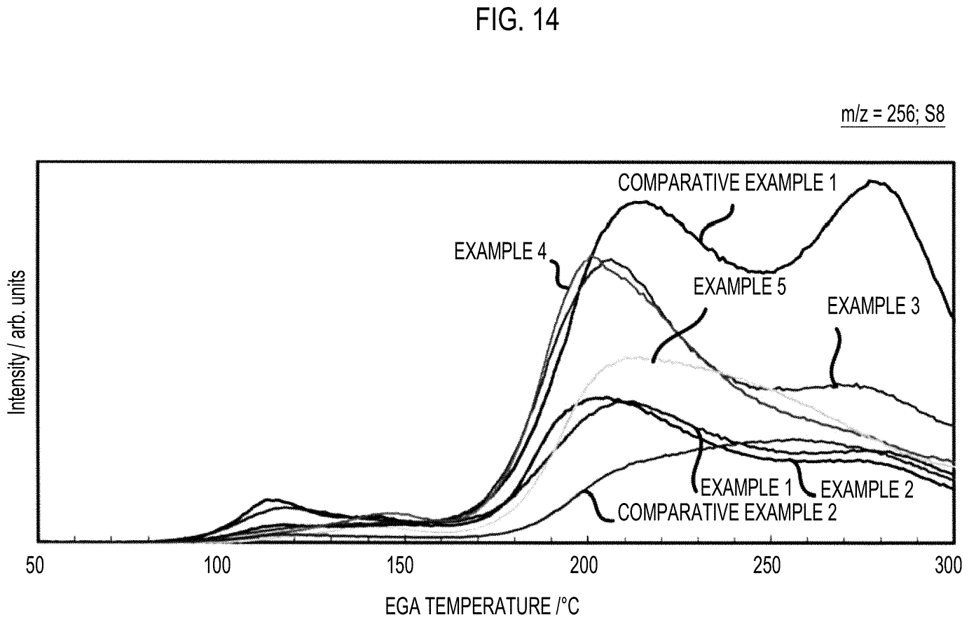

FIG. 14 illustrates the results of TICC focusing on m/z=256. Here, a peak appearing in the range 2 of 170° C. or higher and lower than 250° C. is called a first peak, and a peak appearing in the range 3 of 250° C. or higher and lower than 300° C. is called a second peak. As can be observed from FIG. 14, in Comparative Examples 1 and 2, the peak intensity P2 of the second peak is higher than the peak intensity P1 of the first peak. On the other hand, in Examples 1 to 5, the peak intensity P1 of the first peak is higher than the peak intensity P2 of the second peak. Regarding this point, there was a significant difference between the results of Examples 1 to 5 and Comparative Example 1.

The peak intensities of the first peak and the second peak were further investigated. Table 1 shows the peak intensity ratio P1/P2 of each of Examples and Comparative Examples. As can be seen from Table 1, it can be seen from the peak intensity ratios P1/P2 of Comparative Examples 1 and 2 were less than 1.00. On the other hand, the peak intensity ratios P1/P2 of Examples 1 to 5 were more than 1.00, specifically, in a range of 1.19 to 2.10.

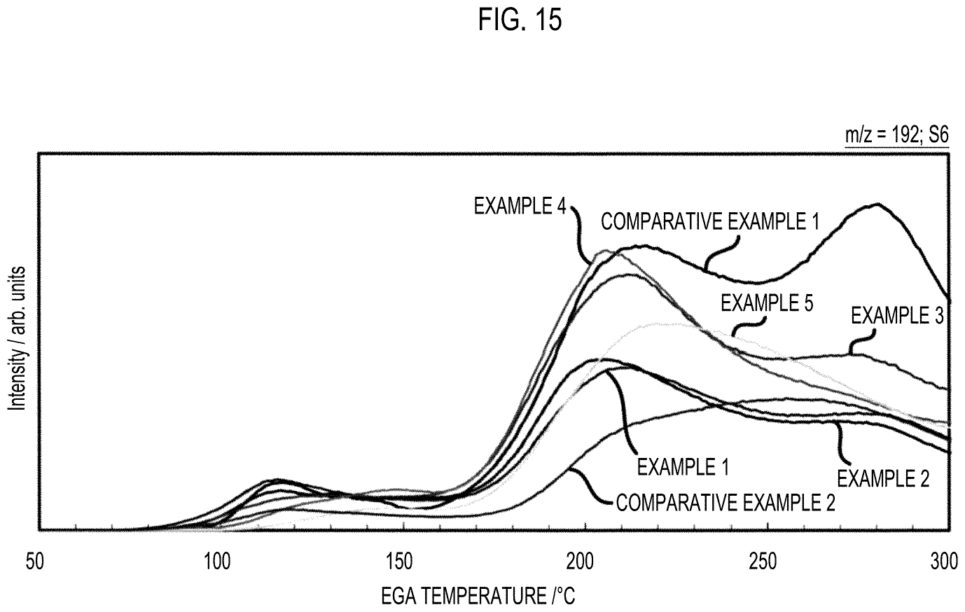

In addition, FIG. 15 illustrates the results of TICC focusing on m/z=192. As can be seen from FIG. 15, it was able to be observed that the peak intensities of the first peak and the second peak had the same tendency as the results of m/z=256.

### Ion Conductivity Measurement

Regarding the obtained solid electrolyte powder, the ion conductivity was measured using an alternating current impedance method. The details are as follows. 80 mg of the solid electrolyte powder was put into a metal tube having a diameter of 1 cm, and was compression-molded at 360 MPa to prepare a pellet. Stainless steel electrodes were attached to both ends of the pellet to prepare a cell, and the ion conductivity of the prepared cell was measured using an alternating current impedance method. The results are shown in Table. 1.

It was found from Table 1 that, in Examples 1 to 5 to which the second solvent was added, the ion conductivity was improved as compared to Comparative Example 1 to which the second solvent was not added. The reason for this is presumed to be that the main peak of Li₆PS₅Cl of the argyrodite structure in the XRD measurement increased. In addition, Examples 1 to 3 had the tendency that, as the vapor pressure of the second solvent decreased, the ion conductivity increased. Further, in Examples 3 to 5, when the content of the second solvent was 30 wt %, the ion conductivity was the highest. The reason for this is presumed to be that the amount of impurity was reduced the most in Examples 3 to 5. In Comparative Example 2, the ion conductivity was extremely low. The reason for this is presumed that the crystal structure of the solid electrolyte was broken due to the addition of NMP.

TABLE 1

| | | | | | | | | | Ion |
|---|---|---|---|---|---|---|---|---|---|
| | | | | | | XRD Measurement | | TG-MS | Conductivity |
| | Second Solvent | | | | | Main | Impurity | Measurement | Measurement |
| | | | Solubility | Vapor | Boiling | Peak | Peak | Peak | Ion |
| | | Content | Parameter | Pressure | Point | Intensity | Intensity | Intensity | Conductivity |
| | Kind | (wt %) | ((cal/cm)^{1/2}) | (kPa) | (° C.) | Ratio | Ratio | Ratio P1/P2 | (mS/cm) |
| Example 1 | Para- | 10 | 8.8 | 0.35 | 162 | 1.01 | 0.84 | 1.58 | 0.32 |
| | Chlorotoluene | | | | | | | | |
| Example 2 | Mesitylene | 10 | 8.8 | 0.25 | 169 | 1.17 | 0.88 | 1.82 | 0.35 |
| Example 3 | Tetralin | 10 | 9.4 | 0.05 | 208 | 1.19 | 0.73 | 2.10 | 0.38 |
| Example 4 | Tetralin | 30 | 9.4 | 0.05 | 208 | 1.18 | 0.58 | 1.90 | 0.46 |
| Example 5 | Tetralin | 50 | 9.4 | 0.05 | 208 | 1.54 | 0.73 | 1.19 | 0.40 |
| Comparative | None | — | — | — | — | 1.00 | 1.00 | 0.96 | 0.19 |
| Example 1 | | | | | | | | | |
| Comparative | NMP | 10 | 11.3 | 0.04 | 202 | 0.01 | — | 0.80 | 0.002 |
| Example 2 | | | | | | | | | |

What is claimed is:

1. A solid electrolyte comprising:
lithium;
phosphorus;
sulfur; and
halogen,
wherein when the solid electrolyte is measured by TG-MS, a first peak derived from cyclic sulfur appears in a temperature range of 170° C. or higher and lower than 250° C., a second peak derived from the cyclic sulfur appears in a temperature range of 250° C. or higher and lower than 300° C., and a peak intensity P1 of the first peak is higher than a peak intensity P2 of the second peak.

2. The solid electrolyte according to claim 1, wherein the solid electrolyte has an argyrodite structure including lithium, phosphorus, sulfur, and halogen.

3. The solid electrolyte according to claim 1, wherein a peak intensity ratio P1/P2 is 1.19 or more and 2.10 or less.

4. The solid electrolyte according to claim 1, wherein the cyclic sulfur is S₈.

5. A solid electrolyte solution comprising a solid electrolyte material that is dissolved in a solvent, wherein:
the solid electrolyte material includes lithium, phosphorus, sulfur, and halogen;
the solvent includes a first solvent in which the solid electrolyte material is soluble and a second solvent in which the solid electrolyte material is insoluble; and
the second solvent has a solubility parameter of 10.5 (cal/cm)^{1/2} or less and has a vapor pressure of 0.5 kPa or less.

6. The solid electrolyte solution according to claim 5, wherein a content of the second solvent in the solvent is 5 wt % or more and 50 wt % or less.

7. The solid electrolyte solution according to claim 5, wherein the number of carbon atoms in the second solvent is 7 or more and 10 or less.

8. A method of manufacturing a solid electrolyte, the method comprising:
a preparation step of preparing the solid electrolyte solution according to claim 5; and
a removal step of removing the solvent from the solid electrolyte solution.

9. The method according to claim 8, wherein the removal step includes a first heating step of heating the solid electrolyte solution at a temperature of 50° C. or higher and 120° C. or lower and a second heating step of heating the solid electrolyte solution at a temperature of 140° C. or higher and 200° C. or lower after the first heating step.
